(19) United States
(12) Patent Application Publication
(10) Pub. No.: US 2024/0132363 A1
(43) Pub. Date: Apr. 25, 2024

(54) BISMUTH-DOPED GERMANOSILICATE FIBER FOR E AND S BAND AMPLIFICATION

(71) Applicants: Huawei Technologies Canada Co., Ltd., Kanata (CA); Université Laval, Québec City (CA)

(72) Inventors: Victor Fuertes de la Llave, Québec City (CA); Lixian Wang, Québec City (CA); Younés Messaddeq, Québec City (CA); Sophie Larochelle, Québec City (CA)

(21) Appl. No.: 18/382,191

(22) Filed: Oct. 19, 2023

Related U.S. Application Data
(60) Provisional application No. 63/417,763, filed on Oct. 20, 2022.

(51) Int. Cl. C01B 33/12

(52) U.S. Cl. CPC C01B 33/12; C01P 2002/54

(57) ABSTRACT

A method for fabricating a Bismuth-doped silica-based optical composition. The method has the steps of: depositing SiO₂ to obtain a silica material, soaking the silica material into an aqueous Bismuth solution, incorporating GeO₂ into the silica material, and vitrifying the silica material at a temperature greater than 1500° C. to obtain the Bismuth-doped silica-based optical composition. In some embodiments, the fabricated Bismuth-doped silica-based optical composition has GeO₂ of greater than 12 mol % (such as 19 mol %) and is suitable for transmitting therethrough optical signals of one or more of E and S bands.

### CROSS-REFERENCE TO RELATED APPLICATION

This application claims the benefit of U.S. Provisional Patent Application Ser. No. 63/417,763, filed Oct. 20, 2022, the content of which is incorporated herein by reference in its entirety.

### FIELD OF THE DISCLOSURE

The present disclosure relates generally to optical fibers and/or optical amplifiers, and in particular to Bismuth-doped germanosilicate fiber for E and S band amplification and/or optical amplifiers using same.

### BACKGROUND

The continuous growth of the internet services and cloud computing requires optical communication systems to have larger data transmission capacity. In prior art, the bandwidth (such as the bandwidth of the C and L bands (having wavelength ranges of 1530 nanometers (nm) to 1565 nm, and 1565 nm to 1625 nm, respectively) provided by the erbium-doped fiber amplifiers (EDFAs) have been continuously expanded. The current C-band EDFA product may provide a bandwidth of 48 nm in comparison to its original bandwidth of 36 nm while the L-band EDFAs may also provide a bandwidth of 48 nm by leveraging the unique property of the erbium (Er) ions located in the phosphor-silicate glass. However, the gain bandwidth of the EDFAs may have already reached the physical limit. Future telecommunication systems may start to utilize the transmission windows of the E and S bands (having wavelength ranges of 1360 nm to 1460 nm and 1460 nm to 1530 nm, respectively), which may require new optical materials therefor.

### SUMMARY

According to one aspect of this disclosure, there is provided a Bismuth-doped silica-based optical composition for transmitting therethrough optical signals of one or more of E and S bands, the Bismuth-doped silica-based optical composition comprising: GeO₂ of greater than 12 mol %.

In some embodiments, the Bismuth-doped silica-based optical composition comprises: GeO₂ of greater than 12 mol % and less than 22 mol %.

In some embodiments, the Bismuth-doped silica-based optical composition comprises: GeO₂ of 19 mol %.

In some embodiments, the Bismuth-doped silica-based optical composition comprises: GeO₂ of greater than 20 mol % and less than 22 mol %.

According to one aspect of this disclosure, there is provided a method for fabricating a Bismuth-doped silica-based optical composition using a modified chemical vapor deposition (MCVD) process and a solution-doping method.

According to one aspect of this disclosure, there is provided a method for fabricating a Bismuth-doped silica-based optical composition; the method comprising: depositing SiO₂ to obtain a silica material; soaking the silica material into an aqueous Bismuth solution; incorporating GeO₂ into the silica material; and vitrifying the silica material at a temperature greater than 1500° C. to obtain the Bismuth-doped silica-based optical composition.

In some embodiments, said depositing the SiO₂ to obtain the silica material comprises: depositing SiO₂ using a MCVD process to obtain the silica material.

In some embodiments, the silica material is a porous SiO₂ soot matrix.

In some embodiments, said incorporating the GeO₂ into the silica material and said vitrifying the silica material comprise: vitrifying the silica material at the temperature greater than 1500° C. while introducing thereto a gas phase precursor having SiCl₄ and GeCl₄ and a flow of O₂ using the MCVD process.

In some embodiments, the aqueous Bismuth solution is an aqueous solution of BiCl₃ with HCl.

In some embodiments, the aqueous Bismuth solution is an aqueous solution having 4.8 millimolar (mM) BiCl₃.

In some embodiments, the aqueous Bismuth solution is an aqueous solution having BiCl₃ in the concentration range of one (1) mM to 10 mM.

In some embodiments, the Bismuth-doped silica-based optical composition comprises GeO₂ of greater than 12 mol % and less than 22 mol %.

In some embodiments, said vitrifying the silica material comprises: vitrifying the silica material at the temperature within a range of 1500° C. to 2000° C.

In some embodiments, said vitrifying the silica material comprises: vitrifying the silica material at 1600° C.

In some embodiments, the method further comprises: drawing optical fibers from the Bismuth-doped silica-based material at a drawing temperature within a range of 1870° C. to 2300° C.

In some embodiments, said drawing the optical fibers from the Bismuth-doped silica-based material comprises: drawing optical fibers from the Bismuth-doped silica-based material at the drawing temperature within a range of 1870° C. to 2180° C.

In some embodiments, said drawing the optical fibers from the Bismuth-doped silica-based material comprises: drawing optical fibers from the Bismuth-doped silica-based material at the drawing temperature within a range of 2000° C. to 2125° C.

In some embodiments, said drawing the optical fibers from the Bismuth-doped silica-based material comprises: drawing optical fibers from the Bismuth-doped silica-based material at the drawing temperature within a range of 2075° C. to 2125° C.

In some embodiments, said drawing the optical fibers from the Bismuth-doped silica-based material comprises: drawing the optical fibers from the Bismuth-doped silica-based material at the drawing temperature of about 2075° C.

In some embodiments, said drawing the optical fibers from the Bismuth-doped silica-based material comprises: drawing the optical fibers from the Bismuth-doped silica-based material at the drawing temperature and at a drawing speed within the range of 5 meters per minute (m/min) to 60 m/min.

In some embodiments, said drawing the optical fibers from the Bismuth-doped silica-based material comprises: drawing the optical fibers from the Bismuth-doped silica-based material at the drawing temperature of 2075° C. and at a drawing speed of about 60 m/min.

According to one aspect of this disclosure, there is provided a Bismuth-doped silica-based optical composition manufactured using the above-described method.

By using suitable parameters disclosed herein (such as a vitrifying temperature greater than 1500° C.), the MCVD method and the solution-doping method may be combined for fabricating the Bismuth-doped silica-based material.

By using the MCVD and solution-doping method disclosed herein in the fabrication of the Bismuth-doped silica-based preform, the fabrication cost of optical fibers, optical amplifiers, and other related products may be significantly lowered compared to the prior-art vapor-phase deposition technique. For example, fibers having about 19 mol % GeO₂ have been fabricated with high optical absorption, luminescence, and gain.

By joint optimization of the content of GeO₂ and the fiber-fabrication parameters, improved gain performance of the Bismuth doped fiber in the E and S bands may be achieved.

### BRIEF DESCRIPTION OF THE DRAWINGS

For a more complete understanding of the disclosure, reference is made to the following description and accompanying drawings, in which:

FIG. 1 is a schematic diagram showing the architecture of an optical multiplex section (OMS) used in an optical transport network (OTN);

FIG. 2 is an image showing an example of an optical amplifier of the OMS shown in FIG. 1;

FIG. 3 is a schematic diagram showing the structure of an optical fiber of the OMS shown in FIG. 1;

FIG. 4 is a flowchart showing a process for fabricating a Bismuth-doped silica-based optical preform composition for fabricating optical fibers, according to some embodiments of this disclosure;

FIGS. 5A to 5C are plots showing the optical performance characterization of Bismuth (Bi) doped germanosilicate fibers having 12 mol % and 19 mol % GeO₂ in the core thereof, respectively, both vitrified at the same temperature and with the same amount of Bi incorporated, wherein

FIG. 5A shows the optical absorption spectrum of the fibers in the spectral range of 1200 nm to 1520 nm,

FIG. 5B shows the corresponding luminescence of the fibers each having a length of 50 meters (m) and under an excitation of 1425 nm, and

FIG. 5C shows the unitary gain under an excitation of 1320 nm;

FIGS. 6A to 6C are plots showing the optical absorption and luminescence dependence with the preform vitrification for three fibers drawn under the same conditions and with the same composition (that is, 19 mol % GeO₂, and with a preform vitrification temperature (T′) of 1500° C., 1600° C., and 1800° C.), wherein

FIG. 6A shows the absorption spectrum of the three fibers in the spectral range of 1200 nm to 1520 nm,

FIG. 6B show the luminescence of the three fibers under an excitation λₚᵤₘₚ=1425 nm, and

FIG. 6C is a plot showing the active absorption of active centers at about 1400 nm as a function of drawing temperature for fibers fabricated with 19 mol % of GeO₂ in the fiber core;

FIG. 7 is a plot showing the refractive index profiles of a plurality of preforms;

FIGS. 8A and 8B show experimental setup for luminescence and gain measurements, respectively, of a plurality of optical fibers fabricated from the plurality of preforms listed in FIG. 7;

FIGS. 9A to 9D are plots showing the absorption spectra in the range of 1200 nm to 1750 nm for fiber A₁ to A₈ listed in Table 3, wherein

FIG. 9A shows the absorption spectra for fibers A₁ to A₈ in the spectral range of 1200 nm to 1750 nm,

FIG. 9B shows the deconvolution of the absorption spectrum for the fiber sample A₁ after removing the background loss,

FIG. 9C shows the absorption of active centers as a function of drawing temperature for fibers A₁ to A₈ at 1330 nm (left axis) and 1405 nm (right axis), and

FIG. 9D shows the absorption of active centers as a function of drawing temperature for fibers A₁ to A₈ at 1650 nm;

FIG. 10 is a plot showing the absorption spectra in the spectral range of 1200 nm to 1750 nm for fiber A₁, B₁ and C₁ listed in Table 3;

FIGS. 11A and 11B are plots showing the deconvolution of the absorption spectra in the wavelength range of 1200 nm to 1520 nm for fibers B₁ and C₁ listed in Table 3, respectively, after removing the background losses;

FIGS. 12A and 12B are plots showing the absorption spectra in the spectral range of 1200 nm to 1750 nm for fibers D₁ to D₈ listed in Table 3 having 12 mol % of GeO₂ (FIG. 12A), fibers E₁ to E₄ having about 5 mol % of GeO₂ (FIG. 12B);

FIGS. 12C and 12D are plots showing the deconvolution of the absorption spectrum for fiber D₂ listed in Table 3 and fiber E₃ listed in Table 3 after removing the background;

FIGS. 13A and 13B are plots showing the active absorption as a function of drawing temperature for fibers D₁ to D₈ at 1330 nm (left axis) and 1405 nm (right axis), and for fibers E₁ to E₈ (having about 5 mol % of GeO₂) at 1350 nm (left axis black) and 1395 nm (right axis), respectively;

FIGS. 14A and 14B are plots showing the absorption spectra in the spectral range of 1200 nm to 1750 nm for fibers B₁, D₂, and E₃ listed in Table 3, and the corresponding normalized spectra, respectively;

FIGS. 15A and 15B are plots showing the luminescence spectra for fibers A₁, B₁, and C₁ listed in Table 3 (each with a fiber length of 50 m), under an excitation of 1425 nm and 1550 nm, respectively; and

FIGS. 15C and 15D are plots showing the luminescence spectra for fibers B₁, D₂, and E₃ listed in Table 3 (each with a fiber length of 50 m), under an excitation of 1425 nm and 1550 nm, respectively.

### DETAILED DESCRIPTION

### Optical Fibers and Optical Transport Networks

Embodiments disclosed herein relate to Bismuth (Bi) doped germanosilicate fiber. Such optical fiber may be used in various optical transport networks (OTNs) for ultra-wideband transmission in a variety of optical wavelength bands such as one or more of the E, S, C, and L bands (having wavelength ranges of 1360 nanometers (nm) to 1460 nm, 1460 nm to 1530 nm, 1530 nm to 1565 nm, and 1565 nm to 1625 nm, respectively).

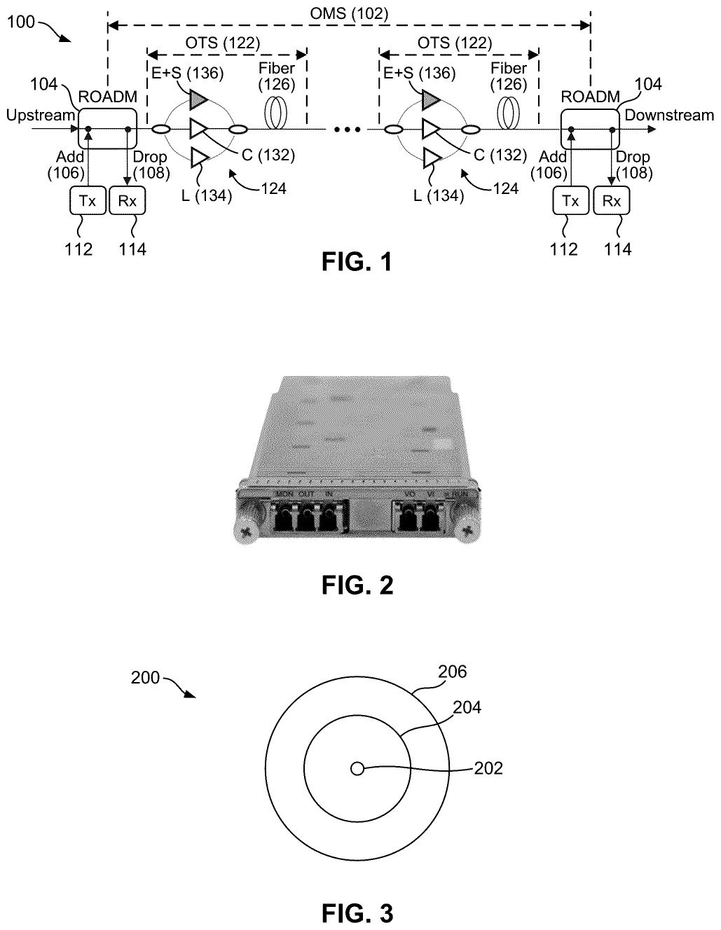

An OTN link usually comprises one or more cascaded optical multiplex sections (OMS). FIG. 1 is a schematic diagram showing the architecture of an OMS 102 used in an OTN 100. As shown, an OMS 102 is defined as the optical link in-between two adjacent reconfigurable add and drop multiplexer (ROADM) nodes 104. The ROADM nodes 104 perform the multiplexing (such as adding (106) and dropping (108)) and grooming of wavelength-division multiplexing (WDM) signals received from a transmitter (Tx) 112 or output to a receiver (Rx) 114.

Between the ROADM nodes 104, the OMS 102 comprises one or more optical transmission sections (OTS) 122 each of which generally comprises a station of optical amplification 124 followed by a transmission fiber 126 with a length of several tens of kilometers. In the ultra-wideband OTN, the station of optical amplification 124 comprises three optical amplifiers: an erbium-doped fiber amplifier (EDFA) 132 for the C band, another EDFA 134 for the L band, and an E+S band amplifier 136. The amplifiers 132 to 136 provide optical gains for compensating the insertion loss of the transmission fiber 126. FIG. 2 shows an example of an optical amplifier. As those skilled in the art understand, optical amplifiers usually comprise optical fibers.

Optical fibers generally have a core-clad structure. As shown in FIG. 3, an optical fiber 200 usually comprises a core 202 coated with a cladding 204, which may be further coated with a low index layer 206.

The optical fiber core 202 may be any suitable doped glass composition such as Al₂O₃—SiO₂, P₂O₅—SiO₂, or GeO₂—SiO₂ (germanosilicate). The cladding may be made of pure SiO₂.

### Bismuth-Doped Optical Fiber Core

The optical fiber core 202 may be Bi-doped glass. As those skilled in the art understand, Bi-doped glasses have been shown as promising materials due to their broadband near-infrared (NIR) luminescent emissions (in the range of 1000 nm to 1800 nm depending on the doped glass composition), which make them promising for broadband amplification systems. In particular, Bi-doped germanosilicate optical fibers can operate in E-, S-, C-, L- and U-telecommunication bands, based on the pumping wavelength.

Bi-doped germanosilicate glasses are characterized by emission bands peaked at about 1400 nm and about 1650 nm. According to the literature, the origin of the 1400 nm emission peak may be attributed to Bi and SiO₂-related defects, formed by interstitial Bi atoms (Bi⁰) and intrinsic defects of glass, that is, ≡Si—Si≡ oxygen vacancies, which is commonly named as silica-related Bismuth active center (BAC-Si), and is the characteristic of any germanosilicate glass matrix independent of the GeO₂ content. In prior art, Bi-doped germanosilicate optical fibers with low GeO₂ content (such as about 5 mol %) are reported for amplification in E+S bands. Conversely, the emission at about 1650 nm (which is associated to Ge-related Bismuth active center (BAC-Ge)) only appears for GeO₂ concentrations greater than 20 mol %. Owing to the dependence of the Bi-related emissions on the glass type, a modification of the germanosilicate glass network may be expected to have significant impact on the Bi NIR luminescence of E and S bands. However, there is little or even no study about the influence of modifying the germanosilicate glass network on these optical bands in prior art.

In prior art, the amplification performance of Bi-doped glasses is still far from that of the EDFAs, mainly due to the uncertainty about the origin of NIR emission in Bi-doped glasses. This unresolved problem that prevents the progress in the field is mainly motivated by the fact that Bi is a polyvalent element, with multiple oxidation states (Bi⁵⁺, Bi³⁺, Bi²⁺, B⁺, and the like). Moreover, Bi is in reduction/oxidation equilibrium in the molten glass during the fabrication process, reducing its oxidation state as melting temperature increases (following the sequence: Bi³⁺→Bi²⁺→Bi⁺→Bi→clusters (such as Bi₂, Bi⁻₂, Bi₃)→(Bi)ₙ, where (Bi)ₙ represents Bi metallic colloids), which can lead to the presence of different NIR active defects, that is, Bismuth active centers (BACs). Therefore, the optical properties of Bi-doped germanosilicate optical fibers may be tailored through the fabrication conditions, such as temperature and heating time, modifying the reduction/oxidation (redox) equilibrium of the Bi ions that form the BACs involved, and the diffusion of the defects that are involved on those BACs. BACs largely determine the spectroscopic properties, performance, and bandwidth of Bi-doped fiber (BDFs). However, no knowledge about the impact of manufacture conditions, including preform and fiber fabrication conditions, on Bi NIR luminescent emissions for this type of fibers is reported in prior art. This lack of process controlling prevents the progress of future Bi-doped germanosilicate optical fiber amplifiers operating in E and S bands.

In prior art, Bi-doped germanosilicate optical fibers with low GeO₂ content in the fiber core, 5 mol %, and fabricated by pure vapor phase deposition have been used for amplification in E+S optical bands. No knowledge about the impact of manufacture conditions, both preform and fiber fabrication conditions, on Bi NIR luminescent emissions for this type of fibers is reported yet, as well as no detailed description about the fabrication process followed. This lack of process controlling prevents the progress of future Bi-doped germanosilicate optical fiber amplifiers operating in E and S bands.

In prior art, silica-based optical fibers are used which have a core-clad structure and 5 mol % of GeO₂ in the fiber core, fabricated by incorporating Bismuth through pure vapor phase deposition technique. However, the relevant details about manufacture process such as preform fabrication temperatures, drawing temperatures or drawing speeds are unclear.

Conventionally, the pure vapor-phase deposition technique may be used to introduce the Bismuth dopant, which is much complicated and costly compared to the classical solution-doping process along with the modified chemical vapor deposition (MCVD) technique characterized by its simplicity and versatility. Some of the experimental difficulties of vapor-phase doping are, among others, condensation of precursor materials during transportation and decomposition of compounds prior to the reaction zone or variation in dopant concentrations over the length of the preform. Thus, the repeatability of the process is generally poor, the preform lengths are shorter, and OH— content is usually higher in the fibers.

In view of the prior-art optical fiber technologies described above, various embodiments of the Bi-doped germanosilicate fibers and the preform and fiber fabrication processes thereof are now described. For better describing of various embodiments of this disclosure, some technical terms are first explained as follows.

Bismuth-doped fiber (BDF) refers to a type of optical fiber in which the element “Bismuth” is used as dopant; the Bismuth-doped fiber may provide optical gains to different optical wavelength bands depending on the chemical content and the laser pumping wavelength. For example, the BACs in a germanosilicate glass fiber may provide gain to the E and S bands, and the BACs in the phosphosilicate glass fiber may provide gain to the O band (1260 nm to 1360 nm).

Bismuth active center (BAC) refers to the optical emission centers based on the Bismuth ions, which may provide optical gains. The Bismuth ions of BAC may have variable oxidation states and/or may be linked to other defects such as the oxygen vacancies.

Bismuth-doped fiber amplifier (BDFA) refers to the optical fiber amplifier that is built based on the BDFs.

Modified chemical vapor deposition (MCVD) refers to a vacuum deposition method used to produce high-quality and high-performance solid materials. The process is often used for the fabrication of optical preforms.

Solution doping is a technique for the doping of rare-earth ions or transition metal ions into the glass material. Generally, the solution-doping process is as the following: firstly, the dopants are dissolved in a liquid solution; then, the silica tube with a porous layer is merged into this liquid so that the dopants may enter the holes in the porous layers; finally, the silica tube is dried and is drawn into an optical fiber whose core contains the dopants. Solution doping is a commonly used method in the industry of optical fibers.

In some embodiments, the Bi-doped germanosilicate fibers and the preform and fiber fabrication processes disclosed herein may allow the use of the conventional technique of MCVD and solution doping for the fabrication of Bi-doped germanosilicate fiber for providing optical gain to the E and S bands. By understanding the role of GeO₂ incorporated in the germanosilicate-based core, the preform and fiber fabrication processes disclosed herein may tailor and enhance the formation of BACs responsible of E and S band emissions, thereby improving the optical performance such as optical absorption, luminescence, and gain of the Bi-doped germanosilicate fibers. Moreover, the preform and fiber fabrication processes disclosed herein allow control and optimization of the parameters involved therein such as the preform vitrification temperature, the fiber drawing temperature, and the drawing speed, to enhance the formation of BACs responsible of E and S band emissions.

In some embodiments, the Bi-doped germanosilicate optical fiber comprises a core-clad structure for amplification in the spectral region of E and S bands. The preform is fabricated by MCVD technique. The Bismuth is doped within the core region 202 and is incorporated by solution doping through an aqueous solution with hydrochloric acid (HCl).

In some embodiments, the optical fiber comprises a core having GeO₂ of greater than 12 mol %, Bi incorporated from an aqueous solution of bismuth chloride (BiCl₃) in the concentration range of one (1) millimolar (mM) to 10 mM, and a remaining core composition of SiO₂ of less than 88 mol %. The Bi concentration is about 0.014 weight percentage (wt %).

In some embodiments, higher GeO₂ content may provide better optical performance of the fiber in the E and S bands, such as higher optical absorption (in the range of 1200 nm to 1500 nm), luminescence (in the range of 1450 nm to 1600 nm under pumping at 1425 nm), and gain (in the range of 1410 nm to 1510 nm under pumping at 1320 nm).

As will be shown below, in some embodiments, the emission at about 1400 nm that provides optical gain in the E and S bands appears for GeO₂ concentrations greater than 12 mol %, which makes the fiber suitable for optical transmission of E band and/or S band.

In some embodiments, preform vitrification temperature may have an influence on the optical performance of the fiber. Despite the fibers are drawn at higher temperature, the thermal history of the preform manufacture may determine the formation of NIR-emitting BACs in the germanosilicate glass matrix. Such an influence is observed in the range of 1500° C. to 2000° C. for fibers having more than 12 mol % of GeO₂.

In some embodiments, the drawing temperature may be within the range of 1870° C. to 2300° C., and the drawing speed is within the range of 5 meters per minute (m/min) to 60 m/min so as to obtain the optimized optical performance of the Bi-doped germanosilicate optical fiber.

In some embodiments, the drawing conditions to maximize the BACs emitting in E and S bands may be simultaneously determined by the GeO₂ content in the core. In some embodiments, the drawing temperature for maximizing the optical absorption increases as GeO₂ content decreases in the germanosilicate glass matrix.

Table 1 below shows examples of fiber fabrication parameters for fabricating Bi-doped germanosilicate fibers, according to some embodiments of this disclosure.

TABLE 1
Example of Fiber Fabrication Parameters for
Fabricating Bi-Doped Germanosilicate Fibers.

| | | | Drawing |
|---|---|---|---|
| | Drawing | | tension |
| GeO₂ | speed | Temperature | (gram |
| (mol %) | (m/min) | (° C.) | (g)) |
| 12 | 5-60 | 1883-2233 | 32-208 |
| 19 | 5-60 | 1870-2180 | 45-176 |

According to some embodiments of this disclosure, the optical fiber core 202 may comprise Bi-doped germanosilicate with GeO₂ of about 19 mole percent (mol %) and SiO₂ of about 81 mol %. Bi is incorporated from an aqueous solution of 4.8 mM BiCl₃. The Bi concentration is about 0.014 weight percentage (wt %).

The preform and fiber fabrication process in these embodiments are as follows:

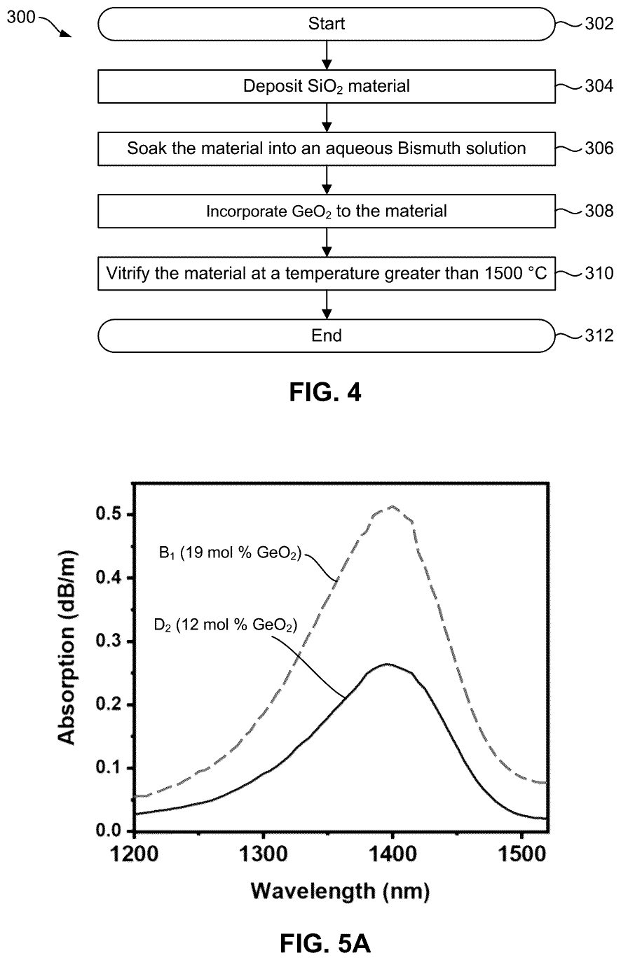

The Bi-doped germanosilicate preform is fabricated by the MCVD method along with the solution-doping technique. FIG. 4 is a flowchart showing a process 300 for fabricating a Bismuth-doped silica-based optical preform composition for fabricating optical fibers, according to some embodiments of this disclosure.

After the process 300 starts (step 302), SiO₂ is deposited to obtain a silica material (step 304). For example, in some embodiments, the MCVD process may be used to spray a precursor of SiCl₄ and a flow of O₂ into a quartz tube to obtain a porous SiO₂ soot matrix.

At step 306, the silica material is soaked into an aqueous Bi solution (such as an aqueous solution of 4.8 mM BiCl₃). In some embodiments, HCl is added at this step to facilitate the dissolution of the Bi ions in the solution.

Then, GeO₂ is incorporated into the silica material (step 308) and the silica material is vitrified at a temperature greater than 1500° C. (for example, 1600° C.) (step 310). The tube may be collapsed at a temperature above 2000° C.

A Bi-doped silica-based optical composition (for example, a preform) is thus obtained and the process 300 ends (step 312).

In some embodiments, steps 308 and 310 may be performed simultaneously, for example, vitrifying the Bi-solution soaked, porous SiO₂ soot matrix obtained at 306 at a temperature greater than 1500° C. while introducing thereto gas phase precursors having SiCl₄ and GeCl₄ and a flow of O₂ using the MCVD process. Then, O₂ converts GeCl₄ into GeO₂ and the Bi-doped silica-based preform is obtained.

When the process 300 is used for fabricating optical fibers, the Bismuth is doped within the core region. In some embodiments, the final preform core fabricated by the process 300 presents a GeO₂ content of 19 mol %. The diameter of the preforms is about 15 millimeters (mm) with a core diameter of about 1.2 mm. In some embodiments, after appropriate sleeving, the optical fiber is drawn from the fabricated preform on a drawing tower at a suitable temperature (such as 2075° C.), speed (such as about 60 m/min), and tension (such as about 80 g of tension). The fabricated optical fiber is single mode with the geometry as shown in FIG. 3, wherein the core 202 of the optical fiber 200 may have a diameter of about 4 micrometers (μm) coated with a cladding 204 having an external diameter of about 125 μm. The core/cladding structure usually has a numerical aperture (NA) of 0.25. The core/cladding structure may be coated with a low index layer 206 of another 125 μm.

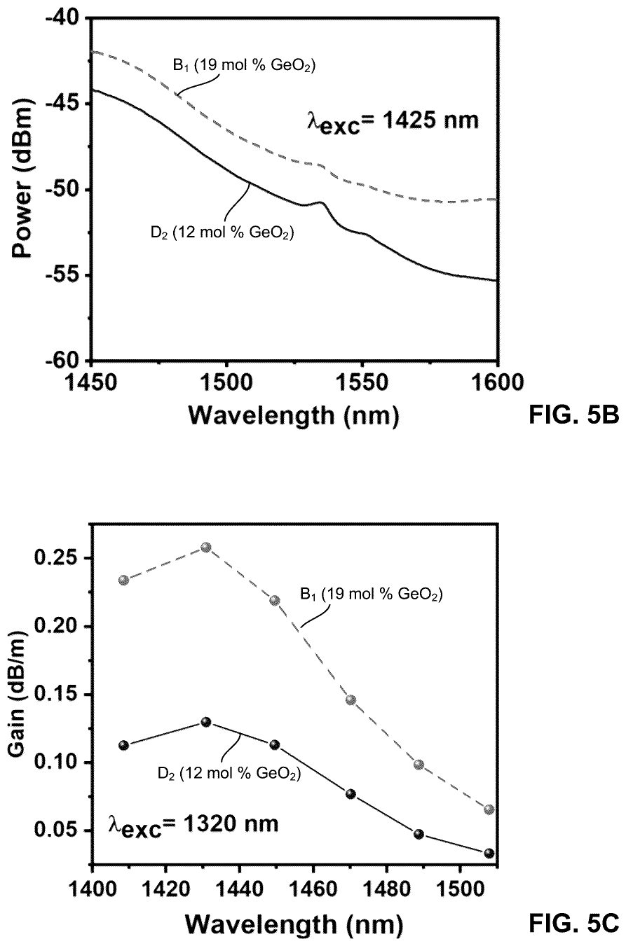

FIGS. 5A to 5C are plots showing the optical performance characterization of Bi-doped germanosilicate fibers in these embodiments having 19 mol % and 12 mol % GeO₂ in the cores thereof (corresponding to fibers B₁ and D₂ listed in Table 3 below), respectively, both vitrified at the same temperature and with the same amount of Bi incorporated, wherein FIG. 5A shows the optical absorption spectra of the fibers in the spectral range of 1200 nm to 1520 nm, FIG. 5B shows the corresponding luminescence of the fibers having a length of 50 meters (m) and after pumping at 1425 nm (that is, λₚᵤₘₚ=1425 nm), and FIG. 5C shows the unitary gain (that is, normalized to the fiber length) of the fibers under an excitation of 1320 nm (that is, λₚᵤₘₚ=1320 nm). In measuring the unitary gain, the input signal source used in the measurements is a 6-line comb source spanning a wavelength range of 1408 nm to 1508 nm. The active fiber is bi-directionally pumped with 400 milliwatt (mW) pump power using a single-mode, 1320 nm laser diode, while signal power is kept to −28 decibel-milliwatts (dBm). Splice loss is included in final gain calculation.

It can be seen that a maximum at 1430 nm is reached for fibers B₁ and D₂ in this range, wherein the maximum of fiber B₁ is 0.26 dB/m and is a two-fold increase from that of fiber D₂. Furthermore, for a given glass composition, there may exist a dependence with the drawing and preform fabrication conditions as described above. It has been shown that, while maintaining the Bi dopant concentration constant, higher GeO₂ content in the glass matrix gives rise to better optical performance of the fiber in the E and S bands, such as higher optical absorption (in the range of 1200 nm to 1500 nm), higher luminescence (in the range of 1450 nm to 1600 nm under pumping at 1425 nm), and higher gain (in the range of 1410 nm to 1510 nm under pumping at 1320 nm). Thus, fibers with a GeO₂ content greater than 12 mol % (for example, 19 mol %) may boost the gain in this spectral range.

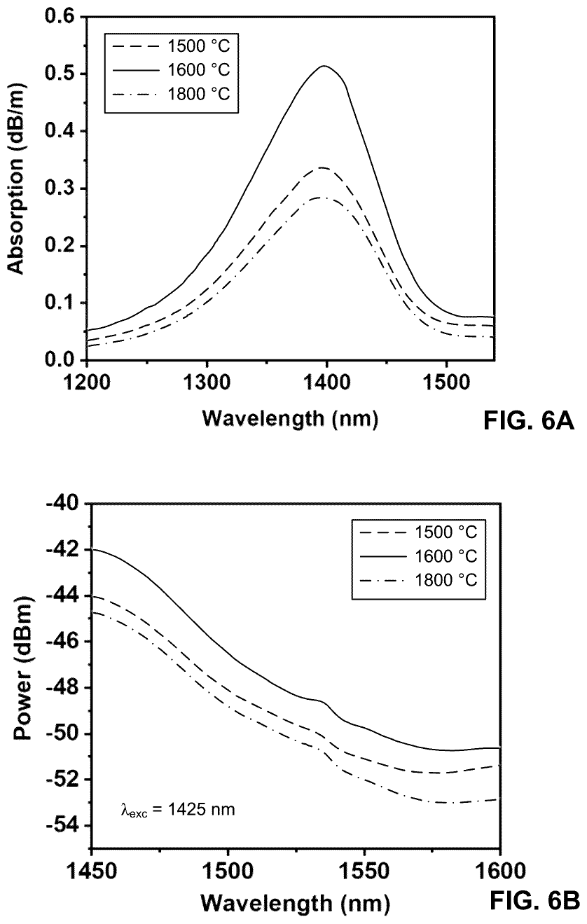

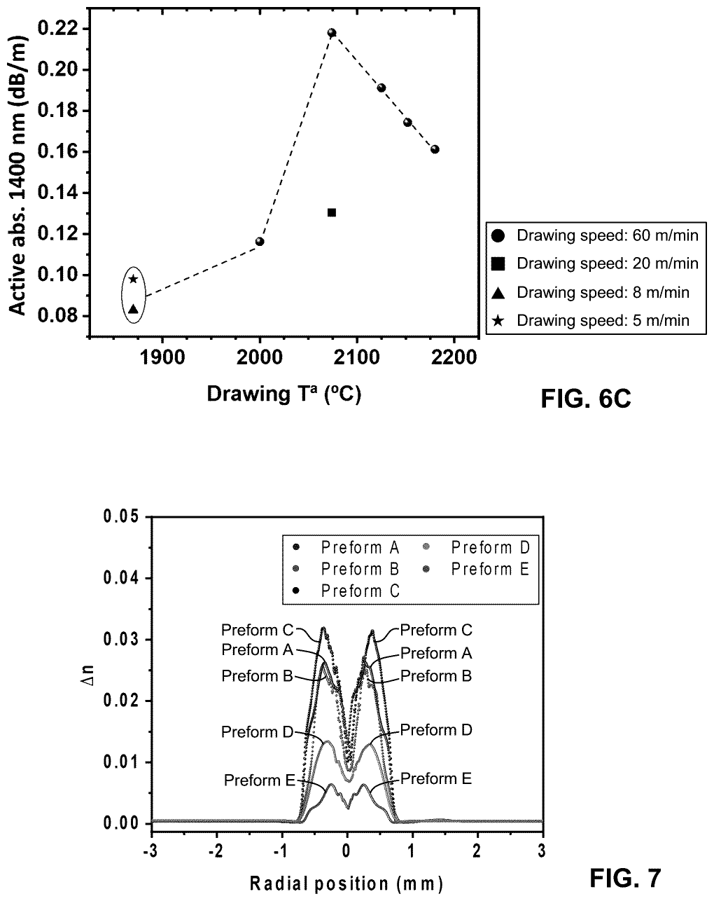

In some embodiments, preform vitrification temperature may have an influence on the optical performance of the fiber. Despite the fibers are drawn at higher temperature, the thermal history of the preform manufacture may determine the formation of NIR-emitting BACs in the germanosilicate glass matrix. Such an influence is observed in the range of 1500° C. to 2000° C. for fibers having more than 12 mol % of GeO₂. For example, FIGS. 6A and 6B show the optical absorption and luminescence dependence with the preform vitrification for three 50-m long fibers drawn under the same conditions and with the same composition, that is, 19 mol % GeO₂, and with a preform vitrification temperature (T^{a}) of 1500° C., 1600° C., and 1800° C., wherein FIG. 6A shows the absorption spectrum in the spectral range of 1200 nm to 1520 nm and FIG. 6B show the luminescence under λₚᵤₘₚ=1425 nm. It can be observed that a dependence with the vitrification temperature also exists. The absorption band in FIG. 6A (peaked at about 1400 nm) is enhanced up to 1.8-fold by vitrifying the preform at 1600° C. compared to the one vitrified at 1800° C. Thus, the BACs associated to this absorption band are considerably influenced by the preform processing temperature. Consequently, after pumping at 1425 nm, the luminescence depicted in FIG. 6B follows the same behavior.

In some embodiments, the drawing temperature may be within the range of 1870° C. to 2300° C., and the drawing speed is within the range of 5 m/min to 60 m/min so as to obtain the optimized optical performance of the Bi-doped germanosilicate optical fiber. For example, FIG. 6C shows the active absorption (that is, the absorption after removing the background loss) of active centers at about 1400 nm as a function of drawing temperature for fibers fabricated with 19 mol % of GeO₂ in the fiber core, wherein the fibers are drawn at different speeds: about 60 m/min (represented by the circles in FIG. 6C), about 20 m/min (represented by the square in FIG. 6C), 8 m/min (represented by the triangle in FIG. 6C), and about 5 m/min (represented by the star in FIG. 6C). It is observed that, under a drawing speed of about 60 m/min, as drawing temperature increases, absorption values increase, reaching a maximum at about 2075° C. However, a further increase of drawing temperature beyond 2125° C. leads to a decrease of the absorption. Moreover, a dependence of the active absorption to the drawing speed is also observed for drawings at the same temperature. In particular, at 2075° C., the active absorption is enhanced by about 1.7 fold due to the increase of drawing speed from about 20 m/min (represented by the square) to about 60 m/min (represented by the circles). Conversely, at lower temperatures such as 1870° C., a higher drawing speed leads to lower absorption values, for example, comparing the drawing speed of about 8 m/min (represented by the triangle) to that of about 5 m/min (represented by the star), in which the differences are about 1.2 fold.

### Further Comparisons

In the following further examples of various Bi-doped germanosilicate optical fibers and the fabrication processes thereof are described and compared for illustrating the influence of different glass matrices and fabrication parameters on the luminescent emission behavior of different Bi-doped germanosilicate optical fibers to tailor the optical properties of Bi ions forming BACs.

In the following comparisons, optical fibers are fabricated with a GeO₂ content of about 5 mol %, about 12 mol %, and about 20 mol % by solution doping and MCVD, and under the effect of some preform and fiber fabrication conditions such as various vitrification temperatures, drawing temperatures, and drawing speeds. In particular, absorption measurements and luminescence and gain tests are carried out, and the possible nature of the BACs responsible of the NIR luminescence measured for these optical fibers is described.

Bi-doped germanosilicate preforms are fabricated by the MCVD method along with the solution-doping technique. A porous SiO₂ soot matrix is deposited inside of a quartz tube using the MCVD process and soaked into BiCl₃ water solutions, in which HCl is used to facilitate the dissolution of the Bi ions in the solution. The solution concentration is maintained constant to 1500 ppm for investigating the influence of vitrification temperature and afterwards fiber fabrication conditions on the BACs responsible of the NIR luminescence considered. Then, the doped silica layer is vitrified at 1500° C. to 1800° C. (see Table 2). Finally, the tube is collapsed above 2000° C. During the process, GeCl₄ is incorporated in gas phase at different flows, and the final preform core presents a GeO₂ content from 19 mol % to 22 mol % (preforms A to C), 12 mol % (preform D), or about 5 mol % (preform E), which is measured by Energy Dispersive X-Ray Analysis (EDX). The corresponding refractive index profiles (RIPs) for preforms A to E are shown in FIG. 7, and the main fabrication conditions and characteristics are listed in Table 2. An increment of the refraction index Δn as GeO₂ content increases is observed. The diameter of the preforms is about 15 mm with a core diameter of about 1.2 mm.

TABLE 2
Preform Fabrication Conditions and Refractive Index Contrast for
Bi-Doped Germanosilicate Preform Samples, wherein BiCl₃
solution doping concentration is 1500 ppm for all samples

| | Vitrification | GeO₂ | Δn |
|---|---|---|---|
| | temperature (° C.) | (mol %) | (·10⁻³) |
| Preform A | 1800 | 19 | 22 |
| Preform B | 1600 | 19 | 22 |
| Preform C | 1500 | 22 | 28 |
| Preform D | 1600 | 12 | 11 |
| Preform E | 1600 | 5 | 4 |

After appropriate sleeving, different optical fibers are drawn from the fabricated preforms on a drawing tower at different temperatures in the range of 1870° C. to 2200° C., and drawing speeds according to the conditions listed in Table 3. The fibers are single-mode fibers having an external diameter of 125 μm and a core diameter of about 4 μm for the set of fibers drawn from preforms A to C, about 5 μm for those from preform D, and about 9 μm for those from preform E. The corresponding numerical aperture (NA) is around 0.25 to 0.29, 0.18, and 0.11 for preforms A to C, D, and E, respectively.

TABLE 3
Fiber Fabrication Parameters for Different Bi-Doped
Germanosilicate Fiber Samples, wherein fiber nomenclature
indicates the preform from which the fiber is drawn.

| Fiber | Drawing | Temperature | GeO₂ |
|---|---|---|---|
| nomenclature | speed (m/min) | (° C.) | (mol %) |
| A₁, B₁, C₁ | 60 | 2075 | 19-22 |
| A₂ | 60 | 2125 | 19 |
| A₃ | 60 | 2152 | |
| A₄ | 60 | 2180 | |
| A₅ | 60 | 2000 | |
| A₆ | 20 | 2075 | |
| A₇ | 8 | 1870 | |
| A₈ | 5 | 1870 | |
| D₁ | 60 | 2105 | 12 |
| D₂ | 60 | 2180 | |
| D₃ | 60 | 2206 | |
| D₄ | 60 | 2233 | |
| D₅ | 60 | 2004 | |
| D₆ | 20 | 2071 | |
| D₇ | 8 | 1883 | |
| D₈ | 5 | 1883 | |
| E₁ | 20 | 2105 | 5 |
| E₂ | 60 | 2180 | |
| E₃ | 60 | 2206 | |
| E₄ | 20 | 2300 | |

Glass fiber composition is analyzed by means of an Energy Dispersive X-ray (EDX) detector coupled to a FEI QUANTA 3D FEG scanning electron microscopy (SEM), which has a resolution of 1.5 nm at 30 kilovolts (kV) in the secondary electron (SE) mode.

Refractive index profile of the fabricated preforms is measured by using a Photon Kinetics PK2600 Preform Analyzers. For the broadband absorption measurements of the different optical fibers, the cut-back method is applied, and a supercontinuum white light source having a tunable acousto-optic filter with a 3 nm bandwidth is used to obtain a light between 1200 nm and 1800 nm. The typical power after the filter is set to −20 dBm for all wavelengths to prevent any emission of the active fiber.

An optical power meter is used to record the peak average power of the output signal while the length of the optical fiber is 100 m. After recording the peak average power, the fiber is cut to a reference length of one (1) meter. The corresponding peak average power is measured again, and the absorption is then calculated by the ratio of the difference between power and length during the cut-back process. The splice point before the fiber is fixed to ensure the same splice loss.

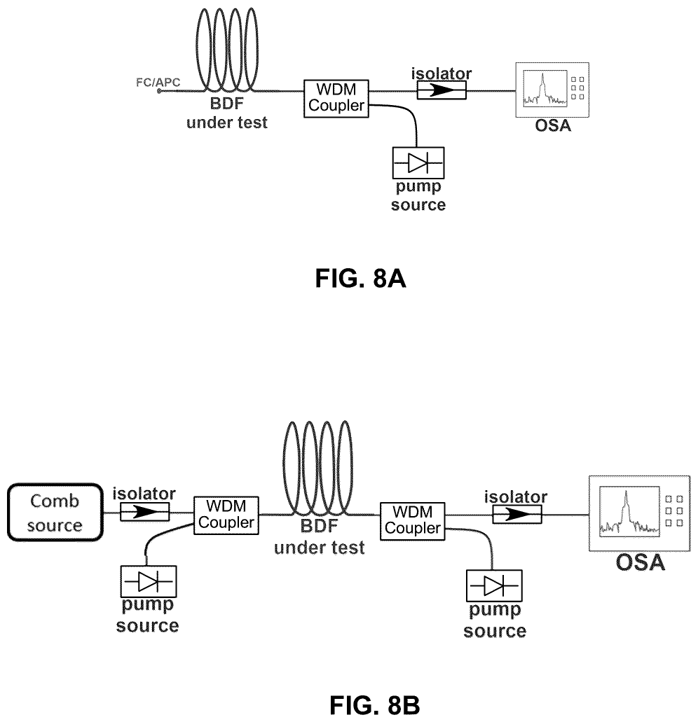

FIGS. 8A and 8B show experimental setup for luminescence and gain measurements, respectively, of a plurality of optical fibers fabricated from the above-listed preforms, wherein BDF refers to Bismuth-doped fiber, WDM refers to wavelength division multiplexer, and OSA refers to optical spectrum analyzer.

The luminescent characterization is measured by using the experimental setup shown in FIG. 8A, using two different pump source wavelengths of 1425 nm and 1550 nm, in order to excite both absorption bands observed in the corresponding absorption spectra. For 1425 nm, a laser source module with 800 mW is used, while for 1550 nm a distributed feedback laser connected to a high power Er-doped fiber amplifier is considered. For all samples, the length of the Bi-doped optical fiber is 50 m, and the pump power is 500 mW. An FC/APC pigtail and an isolator are inserted to suppress unwanted reflection for re-emission.

The unitary gain measurement for the fabricated fibers was performed by using the experimental setup shown in FIG. 8B. The fiber lengths are 30.7 m, 99.0 m, and 35.1 m, respectively, for fiber B₁, D₂, and E₃. The input signal source used in the measurements is a 6-line comb source spanning the 1408 nm to 1508 nm wavelength range. All active fibers are bi-directionally pumped with 400 mW pump power using a single-mode 1320 nm laser diode while the signal power is kept to −28 dBm in order to achieve high inversion level. All fibers are in fully inverted condition. Finally, splice loss of all fibers is included in final gain calculation.

### Influence of Preform and Fiber Drawing Conditions on the Optical Absorption in Bi-Doped Germanosilicate Optical Fibers

With above settings, influence of preform and fiber drawing conditions on the optical absorption in Bi-doped germanosilicate optical fibers are now described.

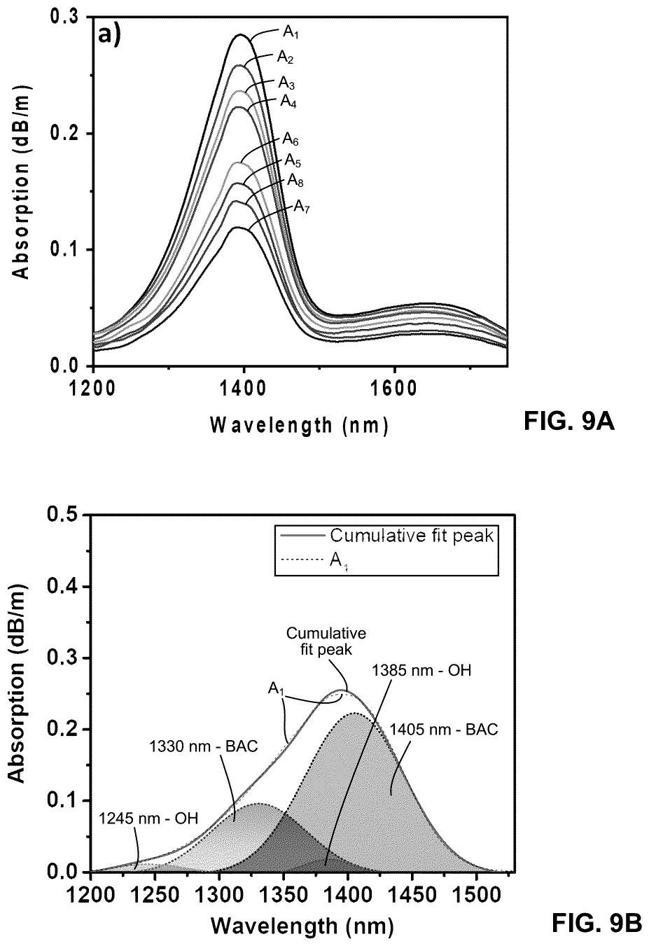

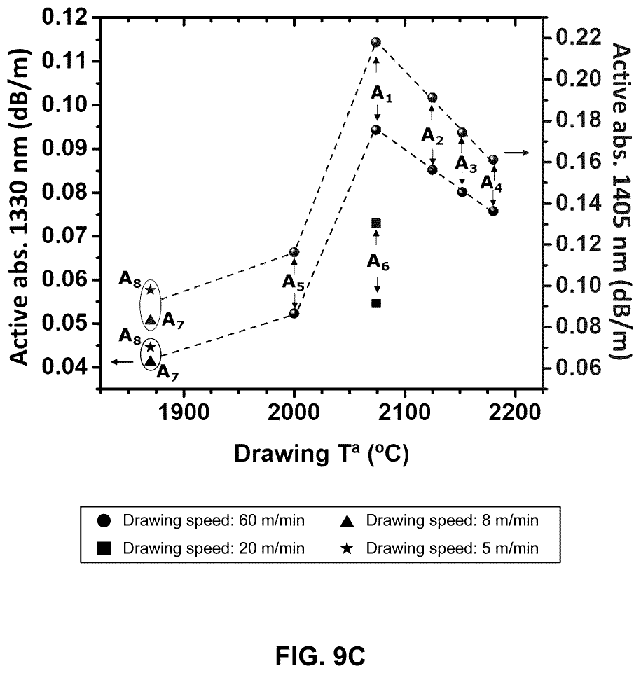

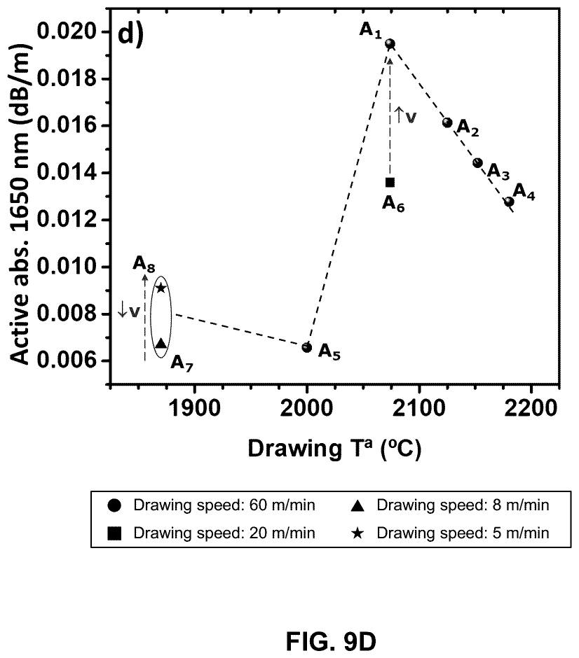

Absorption measurements are carried out to investigate the nature of the BACs in Bi-doped germanosilicate optical fibers and the effect of drawing conditions thereon. FIGS. 9A to 9D shows the absorption spectra in the range of 1200 nm to 1750 nm for fiber A₁ to A₈ listed in Table 3, which have a content of about 19 mol % of GeO₂ and are vitrified at 1800° C., wherein FIG. 9A shows the absorption spectra for fibers A₁ to A₈ in the spectral range of 1200 nm to 1750 nm, FIG. 9B shows the deconvolution of the absorption spectrum for the fiber sample A₁ after removing the background loss, FIG. 9C shows the absorption of active centers as a function of drawing temperature for fibers A₁ to A₈ at 1330 nm (left axis) and 1405 nm (right axis), and FIG. 9D shows the absorption of active centers as a function of drawing temperature for fibers A₁ to A₈ at 1650 nm. The fibers used for obtaining FIGS. 9C and 9D are drawn at different speeds, according to Table 3, wherein circles represent a drawing speed of about 60 m/min, the square represents a drawing speed of about 20 m/min, the triangle represents a drawing speed of about eight (8) m/min, and the star represents a drawing speed of about five (5) m/min.

As can be seen, the Bi-doped fibers exhibit absorption bands at 1395 nm and at 1650 nm which are associated to different BACs characteristic of Bi-doped germanosilicate glasses. Moreover, a remarkable influence of the fiber fabrication conditions is observed on the absorption for all fibers drawn from preform A. In particular, the total absorption may be increased by about 2.4 fold for the band at 1395 nm, and about 2 fold for the one at 1650 nm by tailoring the drawing temperature in the range of 1870° C. to 2180° C.

To deepen this observed behavior, the deconvolution of the main band peaked at 1395 nm is carried out for all the fibers, and as an example, the deconvolution of fiber A₁ is depicted in FIG. 9B after the background subtraction. This main absorption band may be fitted to four bands peaked at about 1245 nm, 1330 nm, 1385 nm, and 1405 nm, where the bands peaked at 1245 nm and 1385 nm are known as OH absorption while the other two bands are assigned to BACs.

FIG. 9C depicts the BDF active absorption, that is, the absorption after removing the background losses, as a function of drawing temperature for the bands associated with BACs peaked at 1330 nm and 1405 nm. In particular, it is observed that as drawing temperature increases, absorption values for both bands increase, reaching a maximum at about 2075° C. (fiber A₁). However, a further increase of drawing temperature, beyond 2125° C. leads to a decrease of these absorptions linked with different BACs. Then, the maximum is reached in the interval 2075° C.≤T≤2125° C. Moreover, a dependence with the drawing speed is observed for drawings at the same temperature, such as fiber A₁ and A₆, or fiber A₇ and A₈, which is more noticeable at higher temperatures.

In particular, at 2075° C., the active absorption at 1330 nm and 1405 nm is enhanced by about 1.7 fold from fiber A₆ to fiber A₁ due to the increase of drawing speed from about 20 m/min to about 60 m/min. Conversely, at lower temperatures such as 1870° C., a higher drawing speed leads to lower absorption values, as occurs for fiber A₇ which is drawn at about eight (8) m/min, compared to A₈ drawn at about five (5) m/min, in which the differences are about 1.2 fold. These findings indicate a change of the kinetics of the process as a function of temperature and drawing speed. In particular, the active absorption of these BACs is enhanced by 2.3 time to 2.6 times from fiber A₇ to fiber A₁ by tailoring the drawing conditions. It is of particular relevance that both absorption bands (centered at 1395 nm and at 1650 nm) follow the same behavior and may be impacted similarly by the drawing conditions, which suggest that the physical origin of the corresponding BACs may be closely related.

Similarly, FIG. 9D shows the active absorption of fiber A₁ to A₈ at 1650 nm, which displays a similar trend. The absorption reaches a maximum at the same temperature interval, that is, 2075° C.≤T≤2125° C.

A comparison about how the absorption changes as drawing temperature increases under the condition that the fibers are drawn at a constant drawing speed of about 60 m/min, can be made by comparing the sections in which absorption increases from fiber A₅ to fiber A₁ until reaching the maximum and then decreases from fiber A₁ to fiber A₄.

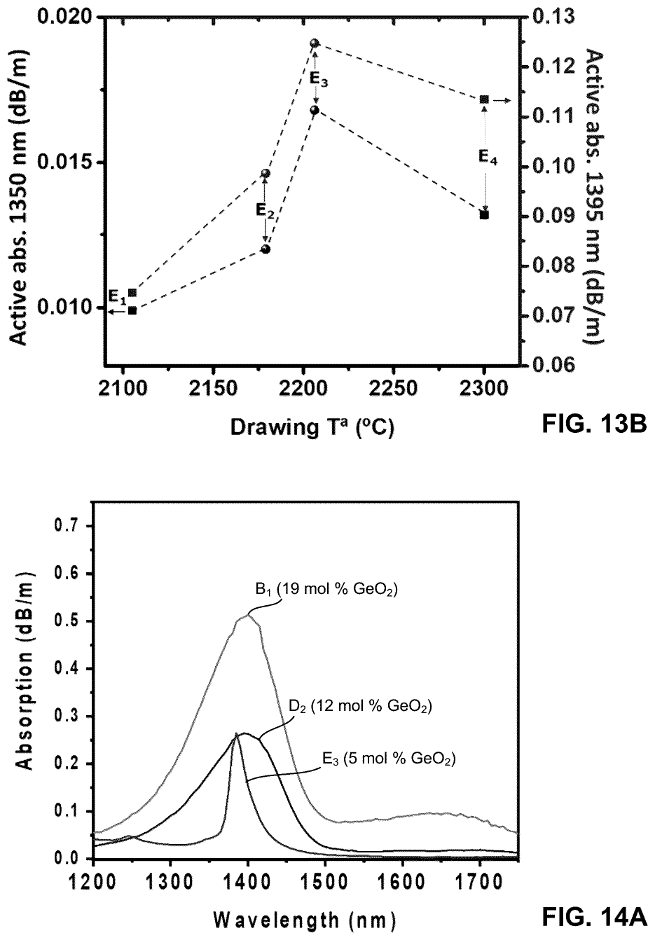

More specifically, an estimation about the rate at which absorption changes as temperature increases for a constant drawing speed of about 60 m/min, may be made by calculating the corresponding slopes of the two sections observed in FIGS. 9C and 9D. Table 4 shows the estimated slopes (in dB·° C. per kilometer (dB·° C./km)) for the sections in which absorption increases from fiber A₅ to fiber A₁ until reaching the maximum, and then decreases from fiber A₁ to fiber A₄. More specifically, the slopes are obtained from the linear fitting for fibers A from FIGS. 9C and 9D, and for fibers D and E from FIGS. 13A and 13B, in the indicated temperature range. Peak position depends on the glass matrix. For fibers A and D absorption, bands are located at 1330 nm and 1405 nm while for fibers E at 1350 nm and 1395 nm. Band at 1650 nm is only noticeable for fibers A.

TABLE 4
Absorption Slopes of Fibers A, D, and E

| | | 1330/1350 nm | 1395/1405 nm | 1650 nm |
|---|---|---|---|---|
| | | (dB · ° C./km) · 10⁻¹ | (dB · ° C./km) ·10⁻¹ | (dB · ° C./km) ·10⁻¹ |
| Fibers A | 2000° C. to 2075° C. | 5.7 | 13.8 | 1.7 |
| | 2075° C. to 2180° C. | −1.8 (0.1) | −5.4 (0.2) | −0.6 (0.1) |
| Fibers D | 2004° C. to 2180° C. | 4.7 (0.5) | 8.9 | — |
| | 2180° C. to 2233° C. | −11.5 (0.3) | −19.9 (0.4) | — |
| Fibers E | 2180° C. to 2206° C. | 2.8 | 9.7 | — |

In general, the BACs associated to the absorption band at 1405 nm are more sensitive to the drawing temperature than those associated to the band at 1330 nm, and therefore the associated slopes are larger. Moreover, the first temperature section 2000° C. to 2075° C. also shows a noticeably larger rate than the temperature section 2075° C. to 2180° C. in which absorption decreases. When the absorption band at 1405 nm is compared with the one at 1330 nm in the range of 2000° C. to 2075° C., the slope is enhanced by 2.4 times, while in the range of 2075° C. to 2180° C., the slope is increased by about three (3) times. In the case of absorption centered at 1650 nm, lower slopes are observed for both temperature intervals. In the first temperature region from fiber A₅ to A₁, the slope is 2.8 times greater than the second one, thus maintaining the trend observed for the other bands. Then, it may be established that for this type of fibers with about 19 mol % of GeO₂, independent of the kind of BAC, the absorption thermal dependence is greater in the drawing temperature interval of 2000° C. to 2075° C. It is also observed that the peak positions are about the same despite the different fiber fabrication conditions.

A similar estimation as in fiber A₁-A₈ about the rate at which absorption changes as drawing temperature increases may be carried out for fibers D and fibers E under the condition that the fibers are drawn at the same drawing speed of about 60 m/min (see Table 4). The BACs associated to the absorption band at 1395 nm and 1405 nm are more sensitive to the drawing temperature than the ones associated to the band at 1330 nm and 1350 nm, and therefore the corresponding slopes are larger.

Unlike fibers A, fibers D exhibits an absorption-decreasing temperature section of 2180° C. to 2233° C., which shows a larger rate than the one in the first temperature section of 2004° C. to 2180° C. in which the intensity increases. For the first section from fiber D₅ to fiber D₂, it is estimated about 1.9-fold when the absorption band at 1405 nm is compared with the one at 1330 nm, and about 1.7-fold for the second temperature range for fiber D₂ to D₄. This change of behavior suggests that these thermally and mechanically activated processes are highly dependent on the glass matrix. For fiber E, a larger slope associated to BACs at 1395 nm regarding the ones at 1350 nm is also observed for the temperature interval of 2180° C. to 2206° C. Further drawings at about 60 m/min will be necessary from 2206° C. to analyze the behavior undergone by the BACs in that matrix.

After demonstrating the impact of temperature in the different BACs between 1200 nm and 1650 nm, the preforms B and C are fabricated, in which the fabrication parameters are maintained approximately invariant except the vitrification temperature, which was decreased from 1800° C. down to 1600° C. and 1500° C., respectively, with respect to preform A (see Table 2). GeO₂ content is about 19 mol % for preforms A and B and slightly larger for preform C (about 22 mol %).

Moreover, according to above description (see FIGS. 9A to 9D), it has shown that the optimum drawing conditions for fibers A₁ to A₈ are the corresponding ones to fiber A₁, and thus fibers drawn at the same conditions are fabricated from preforms B and C, denoted as fibers B₁ and C₁, respectively (see Table 3).

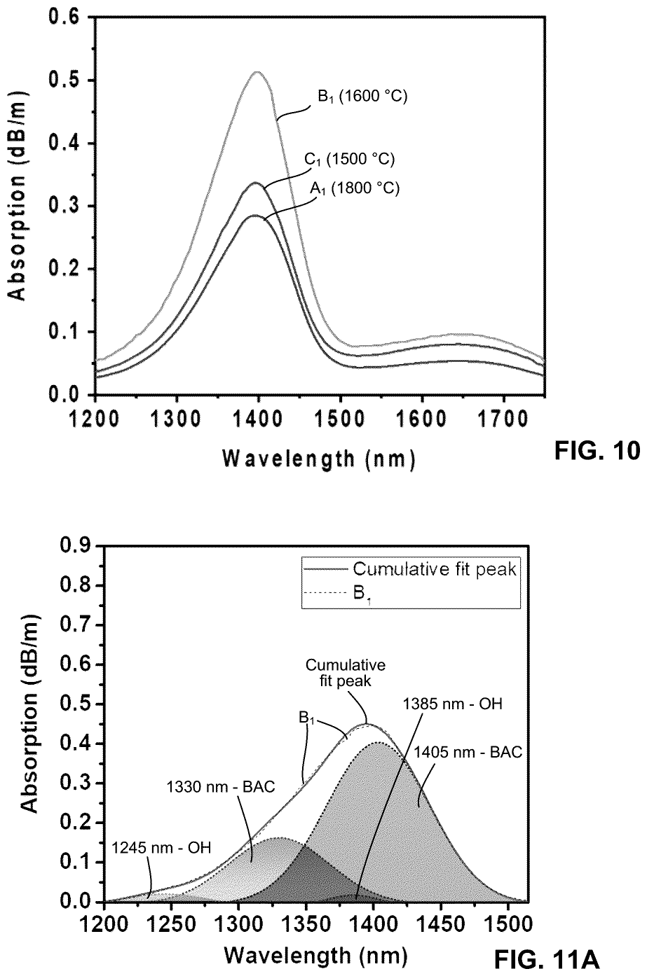

The corresponding absorption spectra are shown in FIG. 10. It can be observed that a dependence with the vitrification temperature also exists, apart from the drawing temperature. Both absorption bands, peaked at 1395 nm and 1650 nm, are enhanced to 1.8-fold by vitrifying the preform at 1600° C. compared to the one vitrified at 1800° C. while having the same glass composition.

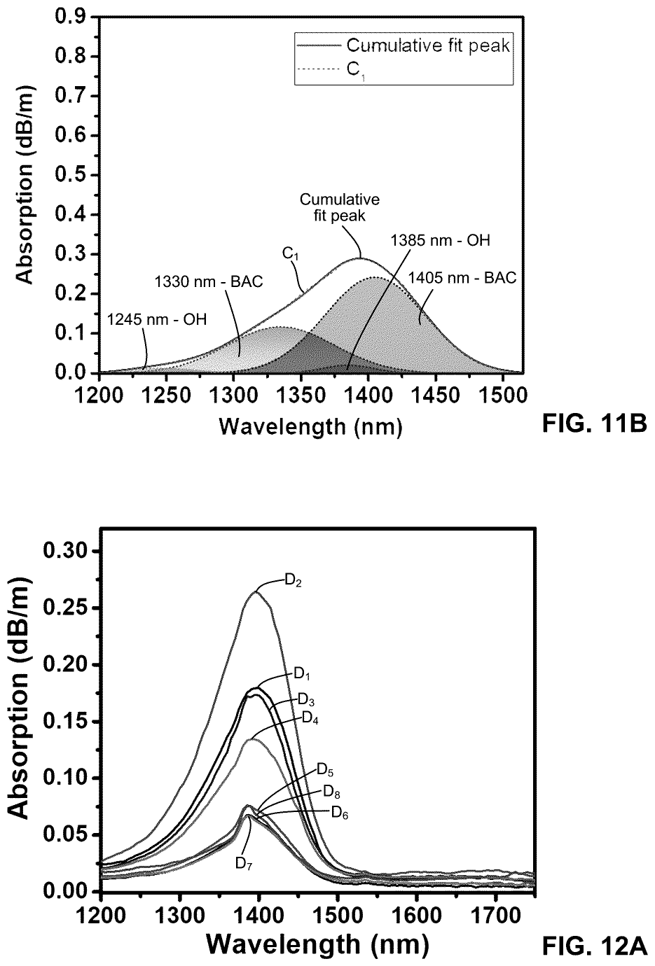

Deconvolution of the absorption spectra for fibers A₁, B₁, and C₁ is shown in FIGS. 9B, 11A, and 11B, respectively. No line shape changes are observed after comparing the corresponding normalized spectra for the three fibers. In literature, band at 1395 nm is assigned to BAC-Si while the band at 1650 nm is assigned to BAC-Ge. Note that GeO₂ content in fiber C₁ is about 3 mol % of higher than that in fibers A₁ and C₁. Based on these results, it is confirmed that vitrification temperature has an impact on BACs-Si/Ge. Moreover, the GeO₂ content may also have an influence, as will be described later.

The above-described observations (which have not been reported in prior art for Bi-doped germanosilicate fibers) are strongly related to the features of the BACs-Si/Ge in the germanosilicate matrix. These fibers A₁ to C₁ are all drawn at 2075° C., which is a higher temperature that the ones considered for the preform vitrification (that is, 1500° C. to 1800° C.). Since all fibers are drawn at the same temperature of 2075° C., the oxidation state of the Bi ions may be the same for all of these fibers. However, remarkable differences with the vitrification temperature are observed (see FIGS. 10A and 10B). Therefore, the thermal history of the manufacturing process also plays an important role in the formation of NIR absorption/emission BACs-Si/Ge in the germanosilicate glass fiber. As described above, such a behavior may also be related to the diffusion of the glass intrinsic defects caused by a temperature and drawing speed effect, and the formation of the corresponding BACs.

### Influence of Glass Matrix Composition on the Optical Absorption in Bi-Doped Germanosilicate Optical Fibers

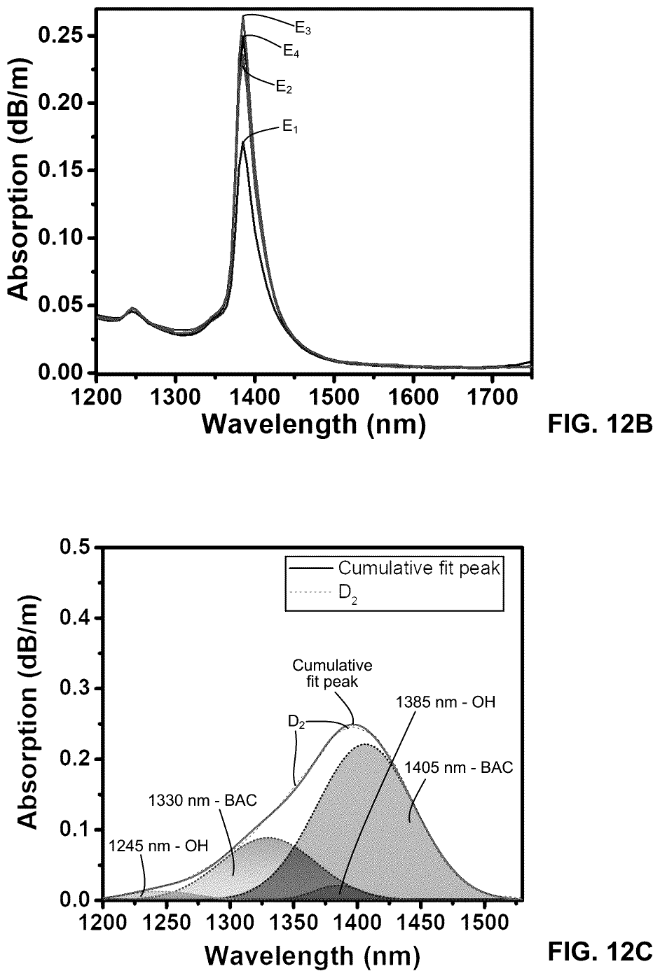

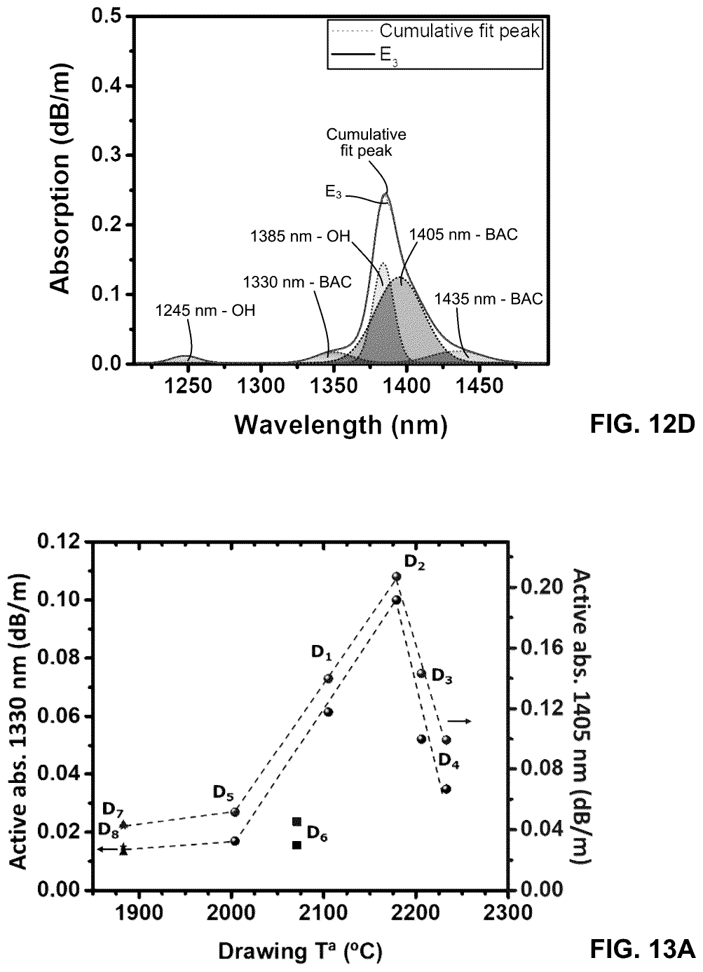

To investigate the origin of the above-described BACs, the glass network is modified by reducing the GeO₂ content thereof. The absorption spectra for fibers D₁-D₅ having about 12 mol % of GeO₂ and fibers E₁-E₈ having about 5 mol % are shown in FIGS. 12A and 12B, respectively, wherein both types of fibers display a dependence on the drawing conditions, similarly to fibers A₁ to A₈.

The band deconvolution at about 1400 nm is carried out, and shown in FIGS. 12C and 12D for fiber D₂ and fiber E₃, respectively, which are the ones with larger absorption (see FIGS. 12A and 12B). While fibers D₁ to D₈ show the same bands as A₁ to A₈ (see FIG. 12C), fibers E₁ to E₄ show remarkable differences (see FIG. 12D). These last fibers show a redshift of 20 nm towards 1350 nm compared to the band previously observed at 1330 nm, as well as a considerable reduction of its area. Similarly, the band peak of fibers D₁ to D₈ is at 1395 nm which is shifted from the 1405 nm band peak of fibers A₁ to A₈. These findings, redshift and area reduction, evidence the modification of the BAC-Si/Ge caused by the glass network change. The OH band at 1385 nm maintains its position while its intensity is considerably more noticeable. Additionally, a band at 1435 nm appears, which has been previously identified in Bi-doped pure silica fibers.

FIGS. 13A and 13B are plots showing the active absorption as a function of drawing temperature for fibers D₁ to D₈ at 1330 nm (left axis) and 1405 nm (right axis), and for fibers E₁ to E₈ at 1350 nm (left axis black) and 1395 nm (right axis), respectively. The fibers D₁ to D₈ and E₁ to E₈ are drawn at different speeds according to Table 3, including a drawing speed of about 60 m/min (represented by the circles), a drawing speed of about 20 m/min (represented by the squares), a drawing speed of about eight (8) m/min (represented by the triangles), and a drawing speed of about five (5) m/min (represented by the stars).

A similar dependence with the drawing conditions as in fibers A₁ to A₈ is observed, wherein as drawing temperature increases, the active absorption progressively increases, reaches a maximum, and then decreases. In particular, in fibers D₁ to D₈, the maximum is at about 2180° C. (fiber D₂), while the absorption at 2206° C. (fiber D₃) has already decreased. Thus, a maximum in the interval 2180° C.≤T<2206° C. is reached. Moreover, similar to the previously described behavior observed for fibers A₁ and A₆ (see FIGS. 9C and 9D), when fiber D₆ is drawn at a drawing speed of about 60 m/min rather than a drawing speed of about 20 m/min, the active absorption thereof may be located in the dashed line of FIG. 13A. The absorption of fiber E₃ drawn at 2206° C. may keep growing, and the absorption of fiber E₄ at 2300° C. is approximately the same as that of fiber E₃, which suggests that a maximum is reached in the interval of 2206° C.≤T<2300° C. Considering that for fiber A₁ to A₈ where the maximum is reached in the interval 2075° C.≤T<2125° C., it is established that the drawing temperature at which the maximum absorption occurs increases as GeO₂ content decreases and is highly dependent on the germanosilicate glass network.

Similar to fibers A, in fibers D and fibers E, the BACs associated to the absorption band at 1395 nm (for fibers A and D) and at 1405 nm (for fibers E) are more sensitive to the drawing temperature than the ones associated to the band at 1330 nm for fibers A and D, and at 1350 nm for fibers E, (see FIGS. 13A and 13B and above description regarding slope of absorption).

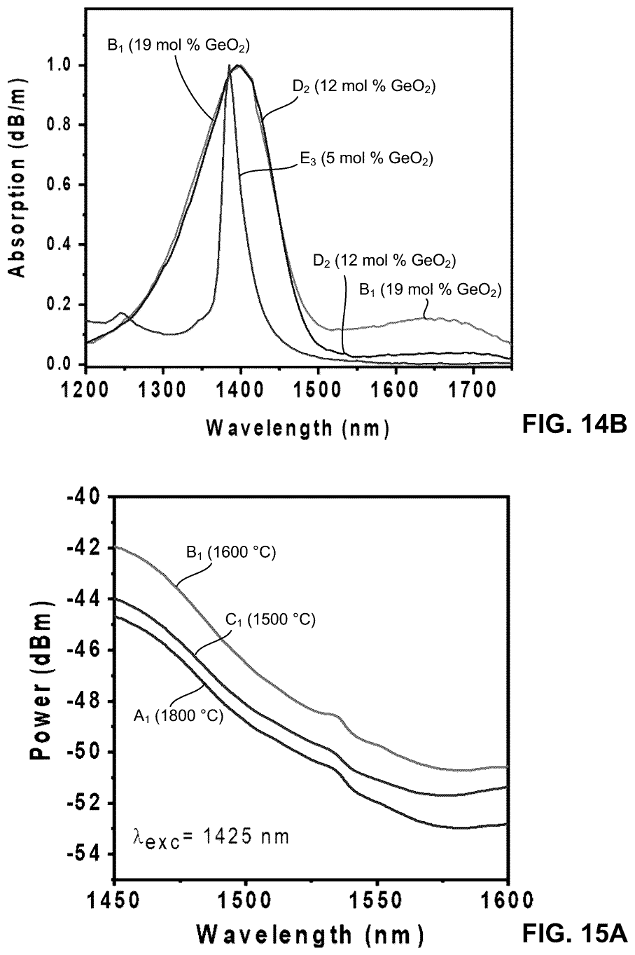

The influence of the germanosilicate fiber glass on the Bi absorption can be clearly observed in FIG. 14A, in which the best fiber B₁, D₂, E₃ of each set of fibers with different GeO₂ composition in terms of the highest absorption is selected, for which all the corresponding preforms are vitrified at 1600° C. As described above, the comparison allows observing that, for both Bi absorption bands, the height and the width of the total and active absorption can be tailored simply by changing the glass composition and the drawing conditions. The normalized spectra for these three fibers B₁, D_{Z}, and E₃ are depicted in FIG. 14B. For both bands, it is observed that a great influence of the GeO₂ content present in the silica-based glass matrix. In particular, when GeO₂ is reduced from 19 mol % to 5 mol %, the line shape of the band at about 1400 nm changes remarkably and the corresponding BACs decrease drastically, while GeO₂ of 12 mol % remains approximately the same. In contrast, the band at 1650 nm practically disappear when GeO₂ is below 20 mol %. Then, it is demonstrated that by tailoring the glass matrix composition one may engineer the BACs responsible of NIR absorption in the range of 1200 nm to 1750 nm. Considering that no quenching concentration processes are present, these findings may also have a similar impact on the corresponding luminescence intensity, as it will be shown.

In literature, multiple works reported for Bi-doped germanosilicate optical fibers have established that the absorption band at about 1400 nm is associated to BAC-Si, formed probably by interstitial Bi atoms (Bi⁰) and intrinsic defects of glass, that is, ≡Si—Si≡ oxygen-vacancies. Herein, it is experimentally observed that when Ge content is reduced in the silica-based glass matrix and therefore SiO₂ content is increased, the intensity of this absorption band is reduced, thereby decreasing the defect density (see FIGS. 14A and 14B). However, if the origin of the BACs associated with the band at about 1400 nm is exclusively related to Si-related defects, it could be expected an increase of the defect density, instead of a decrease.

Moreover, it is observed that the peak position may be affected by the germanosilicate matrix. Thus, the BACs responsible for this absorption band are strongly influenced by Ge, and not merely by Si.

Additionally, it can be seen that the Ge content is directly related with the absorption band peaked at about 1650 nm, which disappears for low GeO₂ concentrations. In this case, the assignment made in literature of BAC-Ge is corroborated.

Furthermore, considering the observed preform and fiber temperature dependence (see FIGS. 9A to 13B), and the fact that absorption and luminescence is affected in Bi-doped fibers by post-annealing treatments after fiber drawing process, there may exist a dependence of the origin of both types of BACs with the presence of intrinsic glass defects such as oxygen vacancies, apart from the oxidation state of the Bi ions involved and Si/Ge atoms forming BAC-Si/Ge. Since fibers are manufactured at high temperatures (typically greater than 2000° C.), the glass and the oxidation state of the Bi ions should be stable for much lower temperatures, but may be remarkably affected by annealing mainly in the interval of 500° C. to 600° C., as reported in literature. Then, the thermal history of the glass may also play an important role. Therefore, it is supported the fact that the point defects present in the glass may diffuse and re-distribute in the glass matrix due to thermal activation along with the pressure of the fiber drawing, even when fibers are heated at temperatures lower than the drawing temperature. Consequently, those defects may link properly with the corresponding Bi-ions and Si/Ge atoms, and the BACs associated to those NIR emissions are enhanced.

### Tailoring Optical Properties in Bi-Doped Germanosilicate Optical Fibers: Luminescence and Gain

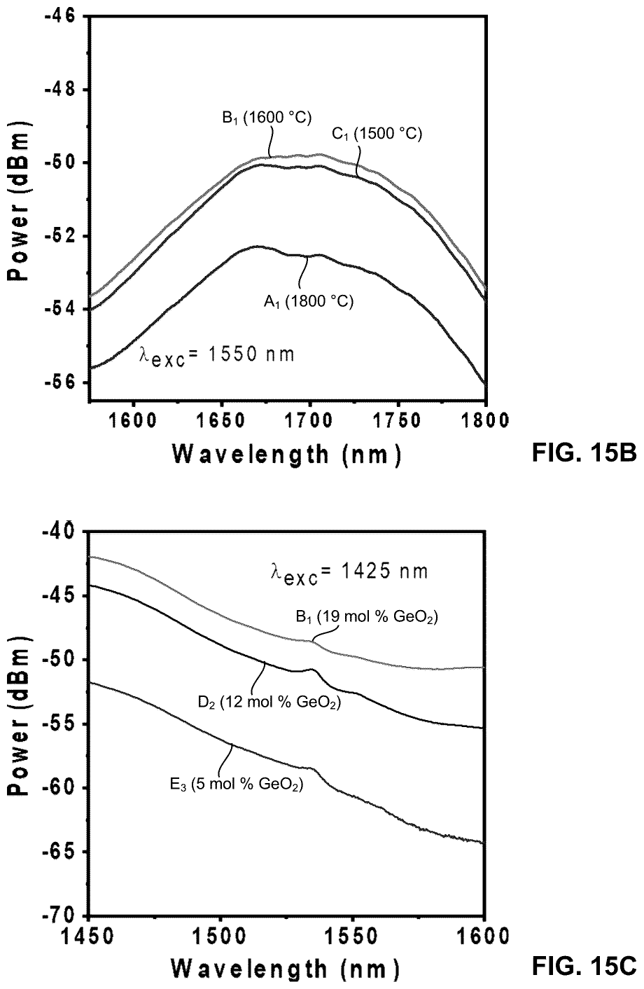

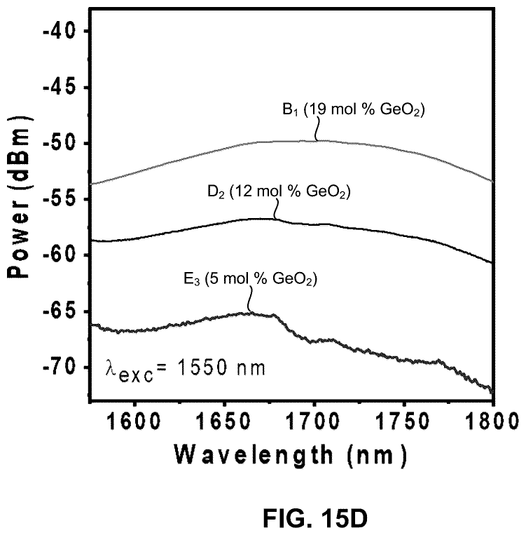

The luminescence spectra for fibers A₁, B₁, and C₁, under an excitation λₚᵤₘₚ=1425 nm and λₚᵤₘₚ=1550 nm is shown in FIGS. 15A and 15B, respectively, wherein the fiber length of each of these fibers is 50 m. These pumping excitation wavelengths are selected in order to obtain an effective population inversion. Consistent to the absorption spectra of FIG. 10A, it is observed that fiber A₁ exhibits larger luminescence than fibers B₁ and C₁ for both excitation wavelengths considered. Although the GeO₂ content in composition of fiber C₁ is about 3 mol % higher than that of fibers A₁ and C₁, it is observed that once a certain number of Ge-related defects are reached, for a GeO₂ content of about 20 mol %, the vitrification temperature plays a more important role, which suggests that those NIR luminescence emitting BACs may be affected by certain diffusion processes that occur in the germanosilicate glass during the fabrication process. At 1425 nm of excitation wavelength, larger differences are observed between fibers A₁ fibers B₁, and C₁ since as it was previously observed in FIG. 10A, the density of BACs decreases considerably when vitrification temperature is different from 1600° C. Moreover, it is observed that the luminescent emission decreases as wavelength increases, dropping by about 7 dBm to 8.5 dBm from 1450 nm to 1600 nm, and covering the E-band, S-band, and even further. The slight bump observed at 1535 nm corresponds to Er³⁺ emission, coming probably from the BiCl₃ precursor used.

Similarly, the same trend is observed for these fibers pumped at 1550 nm. In this case, a broadband luminescence centered at about 1700 nm in the range of 1575 nm to 1800 nm is achieved. Therefore, great part of L-band and the whole U-band are covered. Fiber A₁ and fiber B₁ register similar values since the corresponding BACs excited show subtler differences in the absorption spectra (see FIG. 10A) while fiber A₁ register a considerably lower signal of about 2.7 dBm. Moreover, the emission registered after pumping at 1550 nm has generally a lower intensity than the one obtained after pumping at 1425 nm (consistent to the absorption measurements) since the absorption band peaked at about 1650 nm is considerably less intense than the one at about 1400 nm. In addition, it can be seen that the line shape is the same, that is, by keeping the drawing conditions constant (see Table 3), the BAC-“x” responsible for these emissions are the same species and maintain such observed ratio, even though the GeO₂ content and vitrification temperature were modified (see Tables 2 and 3).

Similarly, luminescence spectra for fibers B₁, D₂, and E₃ (which are the ones with the highest absorption for each corresponding series) are also measured in order to demonstrate the effect on the luminescence of considerably varying the GeO₂ content in the glass matrix (see FIGS. 15C and 15D). As GeO₂ content increases in the silica-based matrix, for a given Bi content, the associated absorption and consequently the luminescence are enhanced. For instance, by pumping at 1425 nm, an enhancement of about 20% in the luminescence at 1530 nm (end of S-band) is measured after comparing fibers B₁ and E₃ which have about 14 mol % of GeO₂ difference. In the case of pumping at 1550 nm, an enhancement of about 30% in the luminescence at 1675 nm (end of U-band) is registered. Moreover, for a given glass composition, one may tailor the luminescence of Bi through the drawing conditions in a similar way as that of fibers A₁ to A₈.

In order to assess the impact of the glass matrix on the amplification performance, gain measurements are carried out by using the setup shown in FIGS. 8A and 8B for fibers B₁, D₂, and E₃ in the range of 1408 nm to 1508 nm and under a pumping wavelength of 1320 nm. No gain was measured for the fiber E₃ (which has 5 mol % of GeO₂) in this spectral range, which agrees with the very low absorption of the corresponding band peaked at 1330 nm (see FIG. 12D). The gain for fibers B₁ and D₂ was shown in FIG. 5C, increasing as GeO₂ content increased in the fiber core, based on previous discussion.

The above results demonstrate that different NIR emitting BACs in the germanosilicate glass matrices may be tailored by means of the glass matrix and the preform and fiber fabrication process (such as through controlling the temperature), which allows the tailoring of the absorption and luminescent emission bands and the gain.

Thus, the number density of BACs with characteristic absorption bands at about 1400 nm and about 1650 nm may be tailored (such as, for example, through controlling the glass composition and manufacturing temperature) for achieving desired absorption and luminescent emission bands and gain. The variation of GeO₂ content in the silica-based matrix is tested while maintaining a constant Bi content used as dopant. As the Ge content increases in the glass matrix, the number density of BACs with characteristic absorption bands at about 1400 nm and about 1650 nm, and the associated luminescence, measured by pumping at 1425 nm and 1550 nm, are increased. Consequently, the gain for the E-/S-band may be tailored.

Moreover, temperature impact is also assessed in a wide range of 1500° C. to 1800° C. during preform and in a wide range of 1870° C. to 2300° C. during fiber fabrication. In both cases, absorption shows a thermal dependence that reaches a maximum for a given temperature. In addition, the emission at about 1400 nm may be caused by both BAC-Si and BAC-Ge. In the optical fibers, the drawing temperature at which the absorption reaches a maximum, increases as GeO₂ content decreases in the germanosilicate glass matrix, from a range of 2075° C.≤T<2125° C. for about 20 mol %, to a range of 2206° C.≤T<2300° C. for 5 mol %. Furthermore, despite the fibers are drawn at higher temperature than the preform vitrification temperature, an optimal vitrification temperature at 1600° C. for fibers having 19 mol % of GeO₂ is also shown. Thus, the thermal history of the manufacturing process also plays an important role in the formation of NIR emitting BACs in the germanosilicate glass matrix.

These results illustrate the feasibility of tailoring optical properties of Bi-doped germanosilicate optical fibers such as absorption, luminescence, and gain in the E and S bands, by appropriate controlling the content of GeO₂, the preform, and fiber-fabrication parameters.

By using the MCVD and solution-doping method disclosed herein in the fabrication of the bi-doped silica preform, the fabrication cost of optical fibers, optical amplifiers, and other related products may be significantly lowered. For example, the fiber having about 19 mol % GeO₂ have been fabricated with high optical absorption, luminescence, and gain.

Those skilled in the art will appreciate that the various embodiments and examples described above, and/or features thereof may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A Bismuth-doped silica-based optical composition for transmitting therethrough optical signals of one or more of E and S bands, the Bismuth-doped silica-based optical composition comprising:
GeO₂ of greater than 12 mol %.

2. The Bismuth-doped silica-based optical composition of claim 1 comprising:
GeO₂ of greater than 12 mol % and less than 22 mol %.

3. The Bismuth-doped silica-based optical composition of claim 1 comprising:
GeO₂ of 19 mol %.

4. The Bismuth-doped silica-based optical composition of claim 1 comprising:
GeO₂ of greater than 20 mol % and less than 22 mol %.

5. A method for fabricating a Bismuth-doped silica-based optical composition, the method comprising:
depositing SiO₂ to obtain a silica material;
soaking the silica material into an aqueous Bismuth solution;
incorporating GeO₂ into the silica material; and
vitrifying the silica material at a temperature greater than 1500° C. to obtain the Bismuth-doped silica-based optical composition.

6. The method of claim 5, wherein said depositing the SiO₂ to obtain the silica material comprises:
depositing the SiO₂ using a modified chemical vapor deposition (MCVD) process to obtain the silica material.

7. The method of claim 5, wherein the silica material is a porous SiO₂ soot matrix.

8. The method of claim 5, wherein said incorporating the GeO₂ into the silica material and said vitrifying the silica material comprise:
vitrifying the silica material at the temperature greater than 1500° C. while introducing thereto a gas phase precursor having SiCl₄ and GeCl₄ and a flow of O₂ using the MCVD process.

9. The method of claim 5, wherein the aqueous Bismuth solution is an aqueous solution of BiCl₃ with HCl.

10. The method of claim 9, wherein the aqueous Bismuth solution is an aqueous solution having BiCl₃ in the concentration range of 1 mM to 10 mM.

11. The method of claim 5, wherein the Bismuth-doped silica-based optical composition comprises GeO₂ of greater than 12 mol % and less than 22 mol %.

12. The method of claim 5, wherein said vitrifying the silica material comprises:
vitrifying the silica material at the temperature within a range of 1500° C. and 2000° C.

13. The method of claim 5, wherein said vitrifying the silica material comprises:
vitrifying the silica material at 1600° C.

14. The method of claim 5 further comprising:
drawing optical fibers from the Bismuth-doped silica-based material at a drawing temperature within a range of 1870° C. to 2300° C.

15. The method of claim 14, wherein said drawing the optical fibers from the Bismuth-doped silica-based material comprises:
drawing optical fibers from the Bismuth-doped silica-based material at the drawing temperature within a range of 1870° C. to 2180° C.

16. The method of claim 14, wherein said drawing the optical fibers from the Bismuth-doped silica-based material comprises:
drawing optical fibers from the Bismuth-doped silica-based material at the drawing temperature within a range of 2000° C. to 2125° C.

17. The method of claim 14, wherein said drawing the optical fibers from the Bismuth-doped silica-based material comprises:
drawing optical fibers from the Bismuth-doped silica-based material at the drawing temperature within a range of 2075° C. to 2125° C.

18. The method of claim 14, wherein said drawing the optical fibers from the Bismuth-doped silica-based material comprises:
drawing the optical fibers from the Bismuth-doped silica-based material at the drawing temperature of about 2075° C.

19. The method of claim 14, wherein said drawing the optical fibers from the Bismuth-doped silica-based material comprises:
drawing the optical fibers from the Bismuth-doped silica-based material at the drawing temperature and at a drawing speed within the range of 5 meter per minute (m/min) to 60 m/min.

20. The method of claim 14, wherein said drawing the optical fibers from the Bismuth-doped silica-based material comprises:
drawing the optical fibers from the Bismuth-doped silica-based material at the drawing temperature of 2075° C. and at a drawing speed of about 60 m/min.
